(19) United States
(12) Patent Application Publication
(10) Pub. No.: US 2010/0185970 A1
(43) Pub. Date: Jul. 22, 2010

(54) User Interface for a Projection Device

(75) Inventor: Alexander Benenson, Salem, OR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: INFOCUS CORPORATION, Wilsonville, OR (US)

(21) Appl. No.: 12/355,533

(22) Filed: Jan. 16, 2009

(51) Int. Cl. G06F 3/048

(52) U.S. Cl. 715/772; 715/810; 715/841

(57) ABSTRACT

A projector, a projection system and a user interface are disclosed. An example projection system may include a projection device adapted to project an image. A user interface may be used in communication with the projection device and may be configured to control a number of projector settings of the projection device. The user interface may be configured to simultaneously display a first level menu item and a list of second level menu items within a second highlighting outline. Display of the list of second level menu items may be invoked by a selection of the first level menu item.

### BACKGROUND

Multimedia projection devices have become popular for purposes such as conducting sales demonstrations, business meetings, classroom training, and for use in home theaters. The projection devices often include many adjustable settings including color, and sharpness, and the like. The projection devices often include an interface configured to allow a user to adjust those settings. However, current projection device interfaces are difficult to navigate, are insufficiently intuitive, and are insufficiently informative. Current interfaces used on projection devices often cause a user to lose his or her place when navigating through a menu structure and/or make it difficult to remember where in the menu structure a sought-after setting can be found so that it may be adjusted.

### SUMMARY

In a first embodiment, the present invention provides a projection system that may include a projection device adapted to project an image. A user interface may be used in communication with the projection device and may be configured to control a number of projector settings of the projection device. The user interface may be configured to simultaneously display a first level menu item and a list of second level menu items within a second highlighting outline. Display of the list of second level menu items may be invoked by a selection of the first level menu item.

### BRIEF DESCRIPTION OF THE DRAWINGS

FIG. 1 is a schematic view illustrating a projection system.

FIG. 2 illustrates an example display of a user interface that may be used to control projector settings for the projection system of FIG. 1.

FIG. 3 illustrates another example display of the user interface that may be used to control projector settings for the projection system of FIG. 1.

FIGS. 4A through FIG. 4D illustrate four different second highlighting outlines that may be included in the user interface.

FIG. 5A is a schematic view illustrating an example menu structure, and FIG. 5B illustrates example buttons that may be used to provide input to the user interface, and to navigate the menu structure.

FIGS. 6A and 6B illustrate further example displays of the user interface that may be used to set and/or change a plurality of projector settings of various example projection devices.

FIG. 7 is a schematic view illustrating an example keypad 24

FIGS. 8A through 8C illustrate still further example displays of a user interface that may be used to control projector settings for the projection system of FIG. 1.

FIG. 9 illustrates an example display of a user interface illustrating a level-0 menu state and a timer.

### DETAILED DESCRIPTION

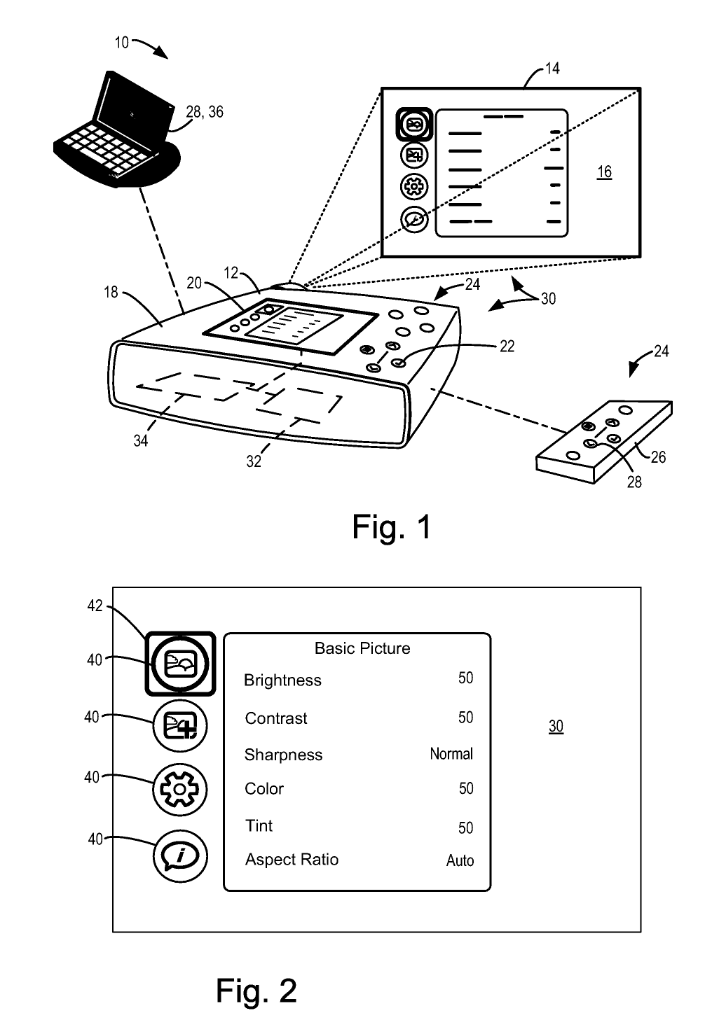

FIG. 1 depicts an example embodiment of the present invention. A projection system 10 may include a projection device 12. The projection device 12 may be adapted to project an image 14 onto any suitable display surface 16, including, but not limited to, a screen, a wall, or other viewing surface or area. As used herein, a projection device 12 or image-generating device may include any suitable display device or image projector, including, but not limited to, a digital projector, a liquid crystal display (LCD) projector, a digital light processing projector, etc.

The projection device 12 may have a projection device body 18 that may include, or may have coupled with it, a display screen 20. The display screen 20 may be configured to display an output, and/or information, pertaining to one or more conditions of the projection device 12. Output, and/or information, pertaining to one or more conditions of the projection device 12 may also, or instead, be provided by, or within, the projected image 14. Input may be provided to the projection device 12 via one or more projection device body buttons 22, on a keypad 24. In some examples the buttons 22 may be physical buttons, for example, they may be mechanically actuated. In other examples the buttons 22 may be virtual buttons on a display that may be actuated with a pointing device, or the buttons 22 may be virtual buttons on a touch-sensitive display.

The display screen 20 may be adapted to display user-readable information. The information displayed may take the form of text, graphic, and/or video images. In some cases, the display screen 20 may be capable of presenting pixelated images. The display screen 20 may be a Liquid Crystal Display (LCD) or any other suitable display.

In this illustrated example, the display screen 20 may be located on the top of the projection device, as shown in FIG. 1. Alternatively, the display screen 20 may be located at the back or on a side of the projection device. When the display screen 20 is disposed on the body of the projection device, it may be referred to as an “on-board” display.

The input provided by the projection device body buttons 22, and the output provided by the display screen 20, and/or the projected image 14, may be included as part of a user interface 30. The user interface 30 may be in communication with the projection device 12, and may be configured to control one or more projector settings of the projection device 12.

A remote control 26 may be linked for communication with the projection device 12. In some embodiments, the remote control 26 may be configured to include remote control buttons 28 that may be provided, in addition to, or as an alternative to, the projector body buttons 22. The remote control buttons 28 may be included as the input, or as part of the input of the user interface 30, and may be configured to adjust the one or more projector settings of the projection device 12.

As a further alternative, the display screen 20 may be located remotely from the projection device body 18, and may be in electronic communication with the projection device via wired or wireless technology. For example, the display screen 20 may be disposed on a remote device, including, possibly, on the remote control 26. Moreover, the user interface 30 may take the form of, or be similar to, a computing device such as a laptop computer 28 as the illustrated example shows. Other example forms of the user interface 30 may include a Personal Data Assistant (PDA) or mobile telephone that may communicate with the projection device via an attached cord, through Bluetooth™ wireless technology, via a modem, or in some other manner.

Moreover, the projection system 10 may include more than one user interface. For example, in some embodiments, it may be desirable to include a first user interface disposed on the body of the projection device 12 and a second remote user interface that communicates with the projection device through, for example, Bluetooth™ wireless technology.

The projection device 12 may include a processor 32 and a memory 34. The processor 32 and the memory 34 may be resident in, or may be coupled with, the projection device 12. Software may be resident in the memory 34, and may be configured to run the user interface 30. The processor 32 may take the form of a central processing unit (CPU), or other suitable controller for controlling operation of the projection device 12. Processor 32 thus may be configured to manage operation and\or function of the projection device 12. For example, processor 32 may manage operational programs, menu programs, user interface programs, etc.

Memory 34 may include volatile memory and\or non-volatile memory. Non-volatile memory may be utilized to store permanent or semi-permanent data. Such non-volatile memory may be any suitable type of non-volatile memory, including, but not limited to, ROM, PROM, EPROM, EEPROM and Flash memory, and combinations thereof. Volatile memory may be utilized to store temporary data, including images and instructions. Volatile memory may include one or more suitable types of volatile memory, such as SRAM or DRAM. Memory 34 may include a number of memory locations to be discussed below.

The one or more projector settings may indicate and/or may affect the one or more conditions of the projection device 12. The user interface 30 may also accept projection device commands that, for simplicity, will be considered herein as included among the many projection device settings. The number of possible projection device settings that may be configured to be adjusted is too numerous to list here. A list of merely illustrative projection device settings may include aspect ratio, keystone, color, brightness, color temperature, lamp life, serial number, source, volume, etc. Many, many settings and/or commands are possible.

A display signal source 36 may be coupled to the projection device 12 for providing content to be projected by the projection device 12. The display signal source 18 may be, for example, a computing device such as the laptop computer 28 as illustrated here. The content from the display signal source 36 may be, for example, a presentation, or a video, or the like. The content may be in the form of one or more digital files. The display signal source 36 may include a processor, and memory, and the like and other elements configured for the function of the display signal source 36. The display signal source 36 may also include functions configured to adjust various source device settings that may adjust the appearance of the content when displayed by the projection device 12. The source device settings may be different from the projection device settings, and results of adjusting one or more projection device settings verses adjusting one or more source settings may be different. The projector settings may take precedence over the source settings, and an adjustment in the projector settings may affect the display of multiple content items from a single or multiple display signal sources 18. In addition, various combinations of source device settings and projection device settings may yield various effects.

FIG. 2 illustrates one instantiation of a menu structure 39 that may be configured for use with the user interface 30, and that may be displayed on the display screen 20 of the projection device 12 illustrated in FIG. 1. A number of first level menu items 40, for example, four first level menu items 40 are shown in this example on the left side of the user interface 30. The first level menu items 40 may be icons. In some embodiments a selected one of the first level menu items may change appearance when selected. For example, they may change color. The instantiation illustrated is one example of a first level of the menu structure 39, and shows a first highlighting outline 42 around a selected one of the first level menu items 40. The interface may be further configured to display other first level menu items 40 in a non-highlighted fashion.

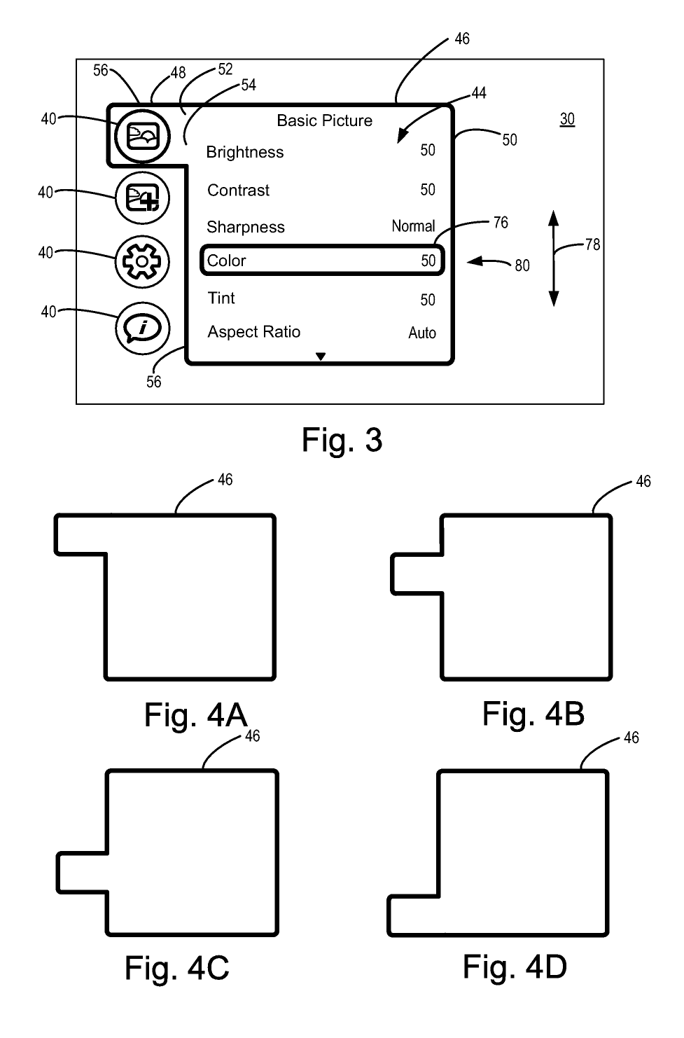

FIG. 3 illustrates another instantiation of the user interface 30 illustrating a second level of the menu structure 39 of the user interface 30. The user interface 30 may be in communication with the projection device 12, and may be configured to control a number of projector settings of the projection device 12. The user interface 30 may be configured to simultaneously display the first level menu item 40, and a list of second level menu items 44 within a second highlighting outline 46. The display of the list of second level menu items 44 may be invoked by a selection of the first level menu item 40.

In some examples, the second highlighting outline 46 may include a first parallelogram 48 around the first level menu item 40, and a second parallelogram 50 around the list of second level menu items 44. The first parallelogram 48 may be smaller than the second parallelogram 50, and may intersect the second parallelogram 50 along a first parallelogram edge 52 of the first parallelogram 48 at an intersecting line 54. The second parallelogram 50 may intersect the first parallelogram 48 along a portion of a second parallelogram edge 56 of the second parallelogram 50 at the intersecting line 54. The intersecting line 54 may not be visible as part of the second highlighting outline 46. In this way the area inside the first parallelogram 48, and the second parallelogram 50 may appear as a single area. Also in this way the second parallelogram 50 may appear as an outgrowth of the first parallelogram 48. The first parallelogram 48 may appear as a tab 56 protruding from the second parallelogram 50. Also in this way the selection history may be made apparent which may make navigation of the menu structure of the user interface 30 more intuitive and easier for a user to follow.

The second highlighting outline 46 may form a 6-sided figure or an 8-sided figure. FIGS. 4A through 4D illustrate four example second highlighting outlines 46. FIG. 4A is similar to the example second highlighting outline 46 shown in FIG. 3, and is a 6-sided figure. The first parallelogram 48 is shown in a position the may be over a first of the first level menu items 40. FIG. 4B illustrates an 8-sided highlighting outline 46 wherein the first parallelogram 48 is shown in a position that may be over a second of the first level menu items 40. FIG. 4C also illustrates an 8-sided highlighting outline 46 wherein the first parallelogram 48 is shown in a position the may be over a third of the first level menu items 40. FIG. 4D illustrates a 6-sided highlighting outline 46 wherein the first parallelogram 48 is shown in a position the may be over a fourth of the first level menu items 42. In all four examples the corners of the second highlighting outline 46 are shown as being filleted. Other configurations are possible such as square, or chamfered, corners. In some examples, the second highlighting outline 46 may have other numbers of sides.

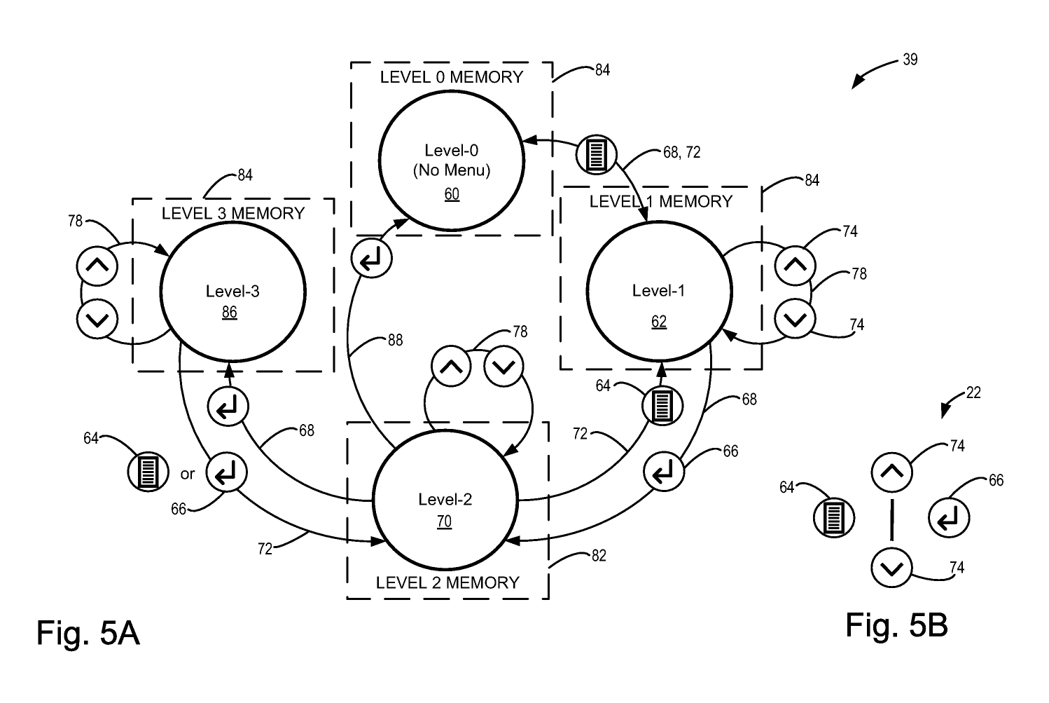

FIG. 5A is a schematic view illustrating an example menu structure 39 having four menu states that may be used to navigate example user interfaces 30 in accordance with various embodiments. Other numbers of menu levels are possible. FIG. 5B illustrates four example buttons 22, that may be the same, or similar to the buttons 22 shown in FIG. 1. The buttons 22 may be used to provide input to the user interface 30, and to navigate the menu structure 39 by transitioning the menu structure 39 from one menu level to another, by scrolling through items, and by selecting items within the menu structure.

The menu structure 39 may include a level-0 menu state 60, a level-1 menu state 62, a level-2 menu state 70, and a level-3 menu state 86. A user selectable menu button 64 may be configured to transition the menu structure 39 from the level-0 menu state 60 to the level-1 menu state 62 and back again. Other inter-level transitions may use a select button 66 to effect a first transition 68 of the user interface 30 from a lower level menu state, for example the level-1 menu state 62, to a higher level menu state for the example level-2 menu state 70, and may use the menu button 64 to effect a second transition 72 of the user interface from a higher level menu state, i.e. the level-2 menu state 62 to a lower level menu state, i.e. the level-1 menu state 62.

Referring still to FIGS. 5A and 5B but also again to FIG. 3, two user selectable scroll buttons 74 may be configured to cause an item identifier 76 to selectively scroll 78 up or down through the list of the second level menu items 44 to a selection position 80. The item identifier 76 may be a fourth highlighting outline. An upper memory, in this example a second level memory 82, and/or memory locations in, for example, memory 34 (FIG. 1), may be configured to save the selection position 76 in the event of the second transition 72, and the selection position may be restored from the second level memory 82 upon a subsequent first transition 68.

Similarly, other menu states may have respective corresponding memories 84 or memory locations that may be configured to save one or more navigational settings that may be restored upon transitioning away from a particular menu state and then subsequently transitioning back to the particular menu state. In this way, memories 82 and 84 may preserve and restore previous menu focuses, for example scroll position, etc. This may make navigation more intuitive and easier to follow when attempting to check, set, or change the settings for the display device.

In some cases the select button 66 may be used to select a particular item or setting that is within the item identifier 76. When selected, in some cases the menu structure may transition to another menu state, as illustrated in the second transition 72 from the level-2 menu state 70 to the level-3 86 menu state. In other cases, when a particular item or setting is selected the menu structure 39 may return to the level-0 menu state 60 as indicated as a third transition 88. Further in some cases when a particular item or setting, or a value is selected while in the level-3 menu state 86 using the select button 66 the menu structure 39 may make a second transition 72 back to the level-2 menu state 70.

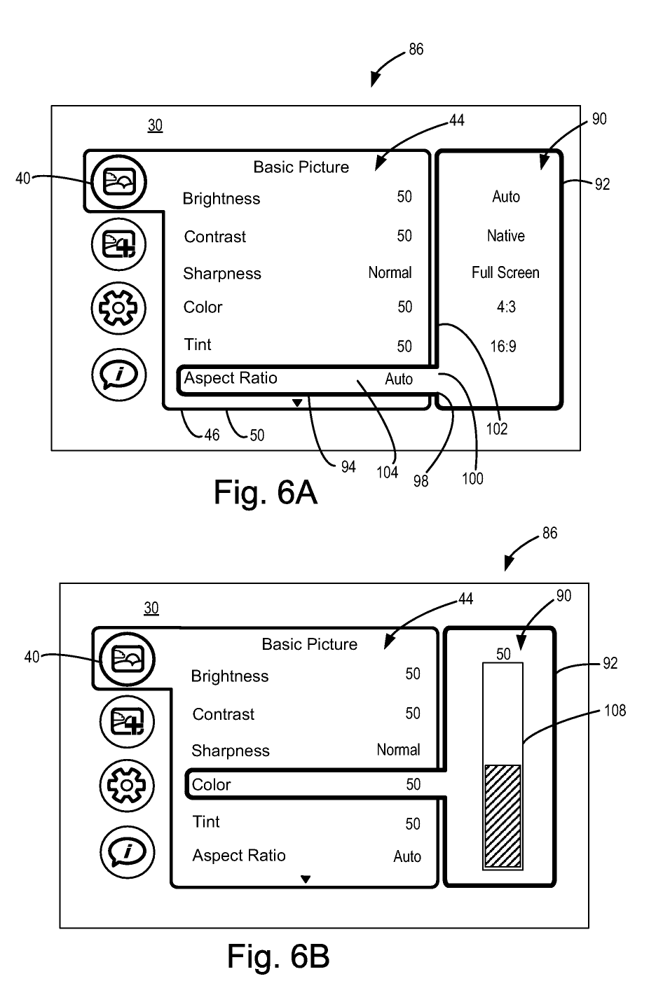

FIGS. 6A and 6B illustrate two example instantiation of the user interface 30 illustrating the level-3 menu state 86 of the menu structure 39 of the user interface 30. The user interface 30 may be further configured to additionally display one or more third level menu items 90 simultaneous with the display of the first level menu item 40 and the list of second level menu items 44 wherein the third level menu item 90 is invoked by a selection of one of the second level menu items 44. The one of the second level menu items 44, and the third level menu item 90 may be displayed within a third highlighting outline 92. The third level menu item 90 may be for example one or more setting or values. A value may be depicted as shown in FIG. 6B using a slider 108, or other visual representation of a value.

Each of the menu states may have one or more focuses. Each focus may have a particular combination, and/or location, of one or more of the first level menu items, the second level menu items, one or more third level menu items, the highlighting outline, item selector, and slider. Each of the menu states have a memory configured to save and to restore a focus. Each focus may be saved in a respective level memory at least upon there being a change from a particular level to another level. As used herein, the term “focus” may, in some cases, refer to an item, or location, on the display that may include one or more features to bring attention to it. For example the term may refer to the currently highlighted menu item. In other cases the term may refer to a projector setting that may be adjustable to affect the clarity of a displayed image. The meaning of the terms use will be clear from the context.

The third highlighting outline 92 may include a third parallelogram 94 around the second level menu item 44, and a fourth parallelogram 96 around the one or more third level menu items 90. The third parallelogram 94 may be smaller than the fourth parallelogram 96, and may intersect the fourth parallelogram 96 along a third parallelogram edge 98 of the third parallelogram 94 at an intersecting line 100. The fourth parallelogram 96 may intersect the third parallelogram 94 along a portion of a fourth parallelogram edge 100 of the fourth parallelogram 96 at the intersecting line 102. The intersecting line 102 may not visible as part of the third highlighting outline 92. The third parallelogram 94 may extend over the second parallelogram 50 into the second highlighting outline 46 at an overlapping portion 104.

In this way the fourth parallelogram may appear as an outgrowth of the third parallelogram. The third parallelogram 94 may appear as a tab protruding from the fourth parallelogram 96. Also in this way the user interface may display multiple levels of focus, including a selection history and the present menu items.

The second highlighting outline may illustrate the menu items with their respective first level menu item, i.e. with the level one icon. Displaying both the menu selections, and the item one level higher in the menu hierarchy, within a highlighting outline may be refereed to as group boxing, or displaying the selection history in a group box. Group boxing can merge to a tab where the selection options and the respective menu/icon may be displayed in a unified focus.

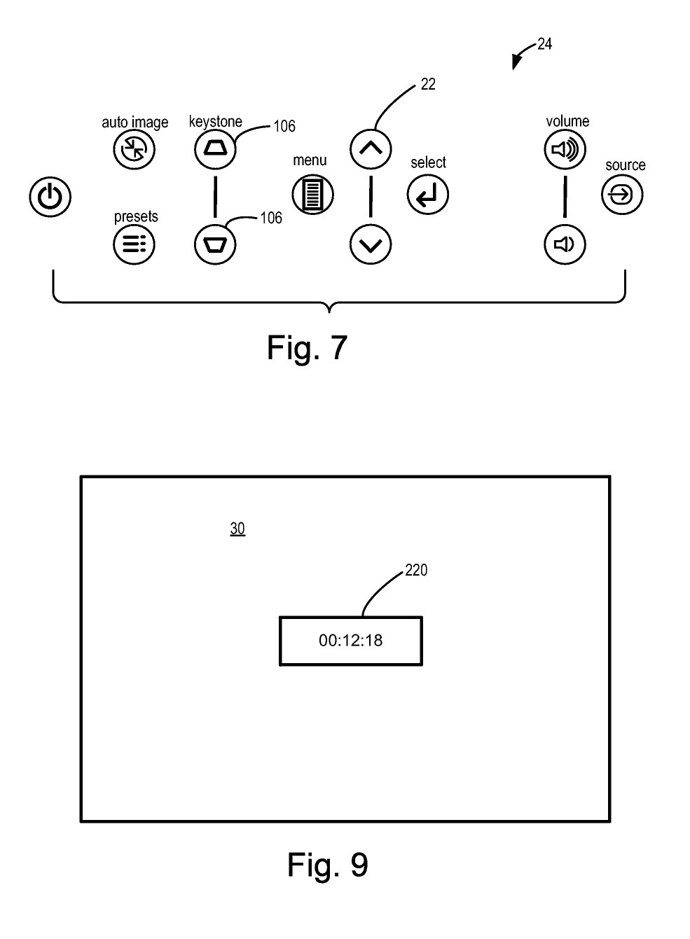

Referring now to FIGS. 5A and 5B and to FIG. 7, FIG. 7 is a schematic view illustrating an example keypad 24 that may be used to set and/or change a plurality of projector settings of various example projection devices in accordance with the present disclosure. The keypad 24 may be part of a projection system that may include a projection device adapted to project an image. A user interface may be in communication with the projection device. The user interface may have a menu structure that may have a first level menu state and a second level menu state. The second level menu state may allow a plurality of projector settings of the projection device to be changed. The plurality of projector settings may not be changeable when in the first level menu state. The keypad 24 may have two or more keys, or button 22 configured to navigate the menu structure, and may be configured to effect a first transition of the user interface from the first level menu state to the second level menu state and to effect a second transition 72 of the user interface from the second level menu state to a the first level menu state. The user interface 30 may also have a non-locked out condition and a locked out condition. The non-locked out condition may allow the first transition and the second transition. The locked out condition may disallow at least the first transition, and therefore any changes of the plurality of projector settings from the second level menu state. However, a subset of the plurality of projector settings may be changeable from the keypad 24 while in either the non-locked out condition or the locked out condition. For example, if the “Basic Picture” menu is locked out, it may not be possible to change the “Keystone” setting in the Basic Picture menu. However, pressing a keystone button 106 on the keypad may change the keystone value. Example menus that may be locked out may include Basic Picture, Advanced Picture, Setup and Status and Service.

When in the locked out condition various preselected privileges may be set for various possible users of the projection system. For example an administrator may have a first set of preselected privileges that may enable the administrator to set and/or change all or most possible projector settings. A regular user may have relatively restricted privileges enabling the regular user to change only a subset of projector settings. In some examples the lockout condition may be effected remotely by a command line interface (CLI).

In various examples it may be possible to turn off the lockout temporarily. One way this may be accomplished may be when the menu structure is in the level-1 menu state. Holding down select for, for example, 10 seconds may turn off the lockout. The menu structure may then transition to the level-2 menu state. After this, the lockout for all menus may remain turned off until the menu structure transitions to the level-2 menu state. The next time the menus are displayed, the lockout may then be enabled again. In some examples the lockout may be turned off lockout permanently. This may be done by, for example the administrator using, for example, CLI commands. In other cases the lockout may be turned off lockout permanently by performing a factory reset.

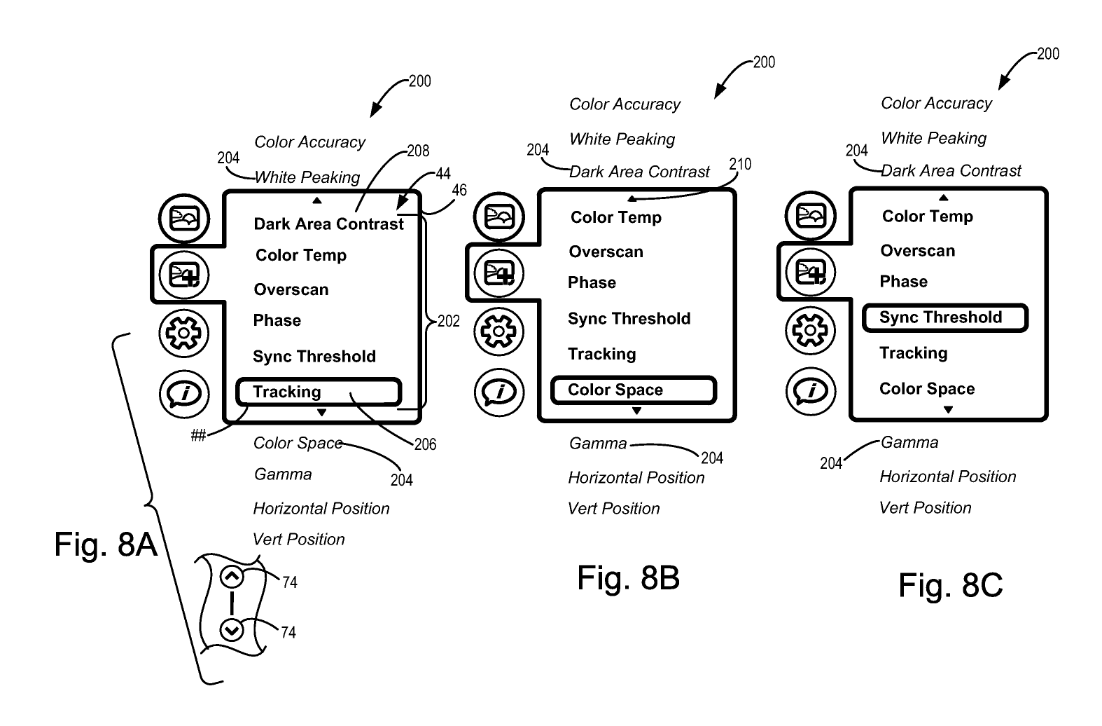

FIGS. 8A, 8B and 8C illustrate a portion of a user interface 30 for the projection device 12 which may be configured to change one or more projector settings of the projection device 12. The user interface 30 may include a list of menu items 200. A visible subset 202 of the list of menu items 200 may be a predetermined number of menu items long. The visible subset 202 may be included within a second highlighting outline 46. The visible subset 202 may be changeable by a sequential appearance of a previously non-visible item 204 to a bottom 206, or a top 208, of the visible subset 202 of the list of menu items 200 and a corresponding sequential disappearance from the other of the bottom 206 or the top 208, of the visible subset 202 of the list of menu items 200 effected by a selection of a scroll button 74 thereby maintaining the visible subset 202 to remain at the predetermined number of menu items long. A continuing list indicator 210 may provide a visual indictor that there are some non-visible items 204. When the visible subset 202 scrolls to include a first or last item of the list of menu items 200 the continuing list indicator 210 may change appearance or disappear, and may assume its original appearance, or reappear when there are non-visible items below the last visible item, or above the first visible item.

FIG. 9 illustrate another instantiation of the user interface 30 included in a projector assembly. The projector assembly may include a projection device adapted to project an image. The user interface 30 may be in communication with the projection device. The user interface 30 may be adapted to display a timer 220 indicating an elapsed time from when a blank screen state was invoked. The timer may be configured to count upward in regular intervals. In this way the duration the projector spends in level-0, but is not turned off may be visually apparent. The blank screen timer may be invoked at a level-0 menu state, the level-0 menu state being reached upon effecting a first transition of the user interface from a first level menu state configured to display at least the first level menu item. In some examples the user interface 30 may be adapted to display a background image around the timer 220. The background image may be a captured picture or a logo.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A projection system comprising:
a projection device adapted to project an image; and
a user interface in communication with the projection device and configured to control a number of projector settings of the projection device, wherein the user interface is configured to simultaneously display a first level menu item and a list of second level menu items within a second highlighting outline wherein display of the list of second level menu items is invoked by a selection of the first level menu item.

2. The projection system of claim 1, wherein the second highlighting outline includes a first parallelogram around the first level menu item and a second parallelogram around the list of second level menu items;
the first parallelogram being smaller than the second parallelogram and intersecting the second parallelogram along a first parallelogram edge of the first parallelogram at an intersecting line; and
the second parallelogram intersecting the first parallelogram along a portion of a second parallelogram edge of the second parallelogram at the intersecting line;
wherein the intersecting line is not visible as part of the second highlighting outline.

3. The projection system of claim 2, wherein the highlighting outline forms a 6-sided figure or an 8-sided figure.

4. The projection system of claim 1, wherein the user interface includes:
a user selectable select button configured to effect a first transition of the user interface from a lower level menu state to a higher level menu state;
a user selectable menu button configured to effect a second transition of the user interface from a higher level menu state to a lower level menu state;
a user selectable scroll button configured to cause an item identifier to selectively scroll up or down through the list of the second level menu items to a selection position; and
a second level memory configured to save the selection position in the event of a second transition, and the selection position being restored from the memory upon a subsequent first transition.

5. The projection system of claim 4, wherein each of the lower level menu state and the higher level menu states have one or more focuses, each focus having a particular combination, and/or location, of one or more of the first level menu items, the second level menu items, one or more third level menu items, the highlighting outline, the item selector, and a slider, and each of the lower level menu state and the higher level menu states have a memory configured to save and to restore a previous focus.

6. The projection system of claim 4, wherein the lower level menu state is a first level menu state and the higher level menu state is a second level menu state, and wherein the first and second level menu items are displayed within the second highlighting outline when the user interface is in the second level menu state, and the first level menu item is displayed within a first highlighting outline when the user interface is in the first level menu state.

7. The projection system of claim 1, wherein the user interface is further configured to additionally display a third level menu item simultaneous with the display of the first level menu item and the list of second level menu items wherein the third level menu item is invoked by a selection of one of the second level menu items, and wherein the one of the second level menu items and the third level menu item are displayed within a third highlighting outline.

8. The projection system of claim 7, wherein the third highlighting outline includes a third parallelogram around the second level menu item and a fourth parallelogram around the third level menu item;
the third parallelogram being smaller than the fourth parallelogram and intersecting the fourth parallelogram along a third parallelogram edge of the third parallelogram at an intersecting line; and
the fourth parallelogram intersecting the third parallelogram along a portion of a fourth parallelogram edge of the fourth parallelogram at the intersecting line;
wherein the intersecting line is not visible as part of the third highlighting outline.

9. The projection system of claim 8, wherein the third parallelogram may extend over the second parallelogram into the second highlighting outline at an overlapping portion.

10. The projection system of claim 1, wherein the projection device has a projection device body, further comprising a display screen on the projection device body configure to display at least an output of the user interface.

11. The projection system of claim 1, wherein the list of second level menu items includes a visible subset of the list of second level menu items, the visible subset being a predetermined number of menu items long, the visible subset being changeable by a sequential appearance of a previously non-visible item to a bottom, or a top, of the visible subset of the list of menu items and a corresponding sequential disappearance from the other of the bottom or the top, of the visible subset of the list of menu items effected by a selection of a scroll button thereby maintaining the visible subset to remain at the predetermined number of menu items long.

12. The projection system of claim 1, wherein the user interface is adapted to display a timer indicating an elapsed time from when the blank screen state was invoked.

13. The projection system of claim 12, wherein the blank screen timer is invoked at a level-0 menu state, the level-0 menu state being reached upon effecting a first transition of the user interface from a first level menu state configured to display at least the first level menu item.

14. A projection system comprising:
a projection device adapted to project an image;
a user interface in communication with the projection device;
the user interface having a menu structure having a first level menu state and a second level menu state, the second level menu state allowing a plurality of projector settings of the projection device to be changed, the plurality of projector settings not being changeable when in the first level menu state;
a keypad having two or more keys configured to navigate the menu structure and configured to effect a first transition of the user interface from the first level menu state to the second level menu state and to effect a second transition of the user interface from the second level menu state to a the first level menu state; and
the user interface having a non-locked out condition and a locked out condition, the non-locked out condition allowing the first transition and the second transition, the locked out condition disallowing at least the first transition, and therefore any changes of the plurality of projector settings from the second level menu state, a subset of the plurality of projector settings being changeable from the keypad while in either the non-locked out condition or the locked out condition.

15. The projection system of claim 14, wherein the user interface is further configured while in the second level menu state to simultaneously display a first level menu item and a list of second level menu items within a second highlighting outline wherein display of the list of second level menu items is invoked by a selection of the first level menu item.

16. The projection system of claim 15, wherein the second highlighting outline includes a first parallelogram around the first level menu item and a second parallelogram around the list of second level menu items;
the first parallelogram being smaller than the second parallelogram and intersecting the second parallelogram along a first parallelogram edge of the first parallelogram at an intersecting line; and
the second parallelogram intersecting the first parallelogram along a portion of a second parallelogram edge of the second parallelogram at the intersecting line;
wherein the intersecting line is not visible as part of the highlighting outline.

17. The projection system of claim 16, wherein the highlighting outline forms a 6-sided figure or an 8-sided figure.

18. A user interface for a projection device configured to change one or more projector settings of the projection device comprising:
a list of menu items;
a visible subset of the list of menu items being a predetermined number of menu items long;
the visible subset being changeable by a sequential appearance of a previously non-visible item to a bottom, or a top, of the visible subset of the list of menu items and a corresponding sequential disappearance from the other of the bottom or the top, of the visible subset of the list of menu items effected by a selection of a scroll button thereby maintaining the visible subset to remain at the predetermined number of menu items long.

19. The user interface of claim 18, wherein the user interface is configured to simultaneously display a first level menu item and the visible subset of the list of second level menu items within a second highlighting outline wherein the display of the visible subset of the list menu items is invoked by a selection of the first level menu item.

20. The projector assembly of claim 18, wherein the user interface is further configured to display other first level menu items in a non-highlighted fashion.

21. A projector assembly comprising:
a projection device adapted to project an image; and
a user interface in communication with the projection device, wherein the user interface is adapted to display a timer indicating an elapsed time from when a blank screen state was invoked.

22. The projector assembly of claim 21, wherein the timer is configured to count upward in regular intervals.

23. The projector assembly of claim 21, wherein the user interface is adapted to display a background image around the timer.

24. The projector assembly of claim 23, wherein the background image is a captured picture or a logo.
